(19) United States
(12) Patent Application Publication
(10) Pub. No.: US 2024/0020665 A1
(43) Pub. Date: Jan. 18, 2024

(54) DECENTRALIZED PROOF OF CREATION

(71) Applicant: Intel Corporation, Santa Clara, CA (US)

(72) Inventors: Sanjay Bakshi, Portland, OR (US); Gautam Singh, Morrisville, NC (US); Geoffrey Gustafson, Saint Johns, FL (US); Muthaiah Venkatachalam, Beaverton, OR (US)

(73) Assignee: Intel Corporation, Santa Clara, CA (US)

(21) Appl. No.: 18/478,234

(22) Filed: Sep. 29, 2023

(51) Int. Cl. G06Q 20/12; G06Q 20/38

(52) U.S. Cl. CPC G06Q 20/123; G06Q 20/3829; G06Q 20/389

(57) ABSTRACT

Embodiments described herein are generally directed to decentralized proof of creation. According to one embodiment, a blockchain and smart contracts, including a social decentralized identifier (DID) contract and multiple creator contracts owned and controlled by respective creators, are maintained by a proof of creation facilitator service. A first social DID for a creator of a digital artifact is created on the blockchain via the social DID contract. Based at least in part on the first social DID, decentralized proof of creation (e.g., a non-fungible token (NFT)) for the digital artifact is created on the blockchain via a creator contract of the multiple creator contracts deployed by or on behalf of the creator.

### TECHNICAL FIELD

Embodiments described herein generally relate to the field of identity verification and proving ownership of digital artifacts and, more particularly, to a solution that enables creators of digital artifacts and buyers/users of digital artifacts to assert their identity using decentralized identities that are not bound to any particular non-fungible token (NFT) marketplace.

### BACKGROUND

Non-fungible tokens (NFTs) are unique cryptographic tokens that are recorded on a blockchain. NFTs are immutable once minted, therefore making them useful for signifying ownership (much like a title to a car), certifying authenticity, and/or otherwise representing digital or physical assets depending on the issuer and the associated metadata. NFT may be monetized (e.g., sold, traded, leased, and the like). For example, the ownership of an NFT is recorded on the blockchain and can be transferred by the owner (which is initially usually the creator) to a buyer. NFT marketplaces are online marketplaces (or digital platforms) that facilitate buying, selling, and/or trading of NFTs.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is a block diagram illustrating an operational environment for a proof of creation facilitator service according to some embodiments.

FIG. 2 is a flow diagram illustrating operations for facilitating decentralized proof of creation according to some embodiments.

FIG. 3 is a flow diagram illustrating operations for creating proof of creation according to some embodiments.

FIG. 4 is a flow diagram illustrating operations for creating a social decentralized identifier (DID) according to some embodiments.

FIG. 5 is a flow diagram illustrating operations for monetization of an NFT minted by a proof of creation facilitator service according to some embodiments.

FIG. 6 is a flow diagram illustrating operations for purchasing an NFT minted by a proof of creation facilitator service according to some embodiments.

FIG. 7 is an example of a computer system with which some embodiments may be utilized.

### DETAILED DESCRIPTION

Embodiments described herein are generally directed to decentralized proof of creation. Existing centralized NFT marketplaces generally operate like app stores (e.g., Apple App Store, Samsung Galaxy, Google Play, and the like), thereby making it impossible for creators of digital artifacts (e.g., digital paintings, 3D models, etc.) to assert their ownership and preserve control over monetization of their creation and/or its derivatives. In addition, the identity vetting procedures employed by such marketplaces are proprietary to the marketplace, essentially, locking the creator to the marketplace.

While several decentralized NFT marketplaces have come into existence with the expressed intention of breaking or “decentralizing” traditional “centralized” online marketplaces, various limitations remain. For example, despite decentralized NFT marketplaces, such as Opensea, and the like having been created with decentralization ethos, it is surprising how little control, if any, they cede to the creators. While these decentralized NFT marketplaces may mint an NFT for each digital artifact on a blockchain to identify it uniquely, they retain control of the blockchain smart contract that mints the NFT, thereby maintaining complete control over monetization terms—just like centralized NFT marketplaces. Meanwhile, there are several published instances in which such decentralized NFT marketplaces have unilaterally changed monetization terms on the creators or censored some creators. In addition, in order for creators to list their creation for sale within a given decentralized NFT marketplace, creators need to upload their original creation to a third-party marketplace server—essentially forcing creators to lose control over their creation.

There are also issues from the buyer/user perspective. For example, buyers/users do not have direct access to proof of creation from the creator of a given digital artifact. Instead, buyers/users must trust the creator identity vetting procedures of the decentralized NFT marketplace as issue. Meanwhile, these proofs of creation are bound to a specific decentralized NFT marketplace—again, leading to marketplace lock-in. Further still, there is no visibility for buyers/users into various sources, such as generative artificial intelligence (AI) or whether sources used by a creator have been authorized by their respective underlying creators.

Various embodiments described herein seek to address or at least mitigate one or more of the limitations of existing decentralized NFT marketplaces by introducing decentralized proof of creation. As described further below, according to one embodiment, a proof of creation facilitator service maintains a blockchain and smart contracts, including a social decentralized identifier (DID) contract and multiple creator contracts (e.g., one for each creator/digital artifact pair or one for each creator) owned and controlled by respective creators. A first social DID is created for a creator of a digital artifact on the blockchain via the social DID contract. Then, based at least in part on the first social DID, a decentralized proof of creation (e.g., an NFT) for the digital artifact is created and persisted to the blockchain via a creator contract of the multiple creator contracts deployed by or on behalf of the creator.

While various examples are described herein with reference to the use of Ethereum Request for Comments 721 (ERC-721) NFTs and/or ERC-1155 smart contracts and an Ethereum blockchain, it is to be appreciated that the methodologies described herein are generally applicable to NFTs issued by other token standards (e.g., Binance Smart Chain Evolution Proposal 20 (BEP-721)), smart contracts that facilitate management of NFTs issued by other token standards (e.g., BEP-1155), and other blockchains (e.g., the BNB Smart Chain (BCS) formerly, the Binance Smart Chain, as well as Polygon, Klaytn, Solana, Arbitrum, Optimism, Avalanche, Zora, Base blockchains, and the like).

In the following description, numerous specific details are set forth in order to provide a thorough understanding of example embodiments. It will be apparent, however, to one skilled in the art that embodiments described herein may be practiced without some of these specific details.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein a “digital artifact” generally refers to anything that exists only in digital form and comes with a distinct usage right, or distinct permission for use. Non-limiting examples of digital artifacts include graphic artwork (e.g., digital drawings or paintings), three-dimensional (3D) models, digital music, software code, digital photography, digital videos, digital films, poetry, books, digital gaming items, virtual worlds, digital trading cards, and other online collectables or other valuable data and code held in digital form.

As used herein, a “non-fungible token” or “NFT” generally refers to a cryptographic asset (a digital representation of value that can be transferred, stored, or traded electronically) on a blockchain with unique identification codes and metadata that distinguish them from each other. An NFT is a unique cryptographic token that may represent a digital artifact that has been tokenized via a blockchain. NFTs can be traded and exchanged for money, cryptocurrencies, or other NFTs, depending on the value the market and owners have placed on them. The difference between cryptocurrencies, which are also cryptographic tokens, is that two cryptocurrencies from the same blockchain are interchangeable—they are fungible. In contrast, while two NFTs from the same blockchain can look identical, they are not interchangeable. ERC-721 and ERC-1155 are the most popular NFT standards on the Ethereum network.

As used herein, a “non-fungible token marketplace” or an “NFT marketplace” generally refers to an online marketplace through which NFTs may be bought, sold, leased, and/or traded.

As used herein a “blockchain” generally refers to a digital database or ledger that maintains a secure, immutable, and decentralized record of transactions in a form of blocks linked together via cryptography and distributed among the nodes of a peer-to-peer network. Non-limiting examples of blockchains include Ethereum, Polygon, Klaytn, Solana, Arbitrum, Optimism, Avalanche, BNB, Zora, and Base blockchains.

As used herein a “blockchain smart contract” or simply a “smart contract” generally refers to code written into a blockchain that executes the terms of an agreement or contract from outside the chain. Smart contracts are programmed to automatically execute when certain conditions are met, and can be used for a variety of purposes, including, but not limited to, buying, selling, leasing, or trading NFTs and minting NFTs. A smart contract may automate actions that would otherwise be completed by the parties to the agreement or the contract, thereby removing the need for the parties to trust each other and reducing or eliminating the need for third-party intermediaries.

As used herein a “creator” generally refers to a person that brings a digital artifact into existence.

As used herein a “decentralized identifier” or “DID” generally refers to an identifier that enables verifiable, decentralized digital identity. A DID may refer to any subject (e.g., a person, an organization, a thing, a data model, abstract entity, etc.). The decentralization aspect of a DID refers to the elimination of the requirement for centralized authorities or a single point of failure in identifier management, including the registration of globally unique identifiers, public verification keys, services, and other information. In contrast to typical, federated identifiers, DIDs are designed so that they may be decoupled from centralized registries, identity providers, certificate authorities, and online marketplaces (e.g., NFT marketplaces). A DID gives the subject the power to directly control their DID without the need to rely on external authorities. A DID is typically associated with a public key (e.g., the public part of an asymmetric key pair that may be contained within the DID) and a private key (e.g., the private part of the asymmetric key pair that is kept secure by the subject). A non-limiting example of a DID is described by Decentralized Identifiers (DIDs) v1.0. Manu Sporny; Amy Guy; Markus Sabadello; Drummond Reed. W3C. Jul. 19, 2022. W3C Recommendation. URL: https://www.w3.org/TR/did-core, which is hereby incorporated by reference in its entirety for all purposes.

As used herein, a “social decentralized identifier” or “social DID” generally refers to a DID that may be validated by (or linked to) a social media account of the subject. For example, a social DID may be mapped to a verifiable social identity claim made by a person through a social media handle (or social media identity) associated with their social media account (e.g., a Facebook account, a Twitter account, an Instagram account, or the like) that establishes the person (associated with the particular social media identity) as the creator or owner of a particular digital artifact. In various examples described herein, each creator is expected to have a social media account followed by their fans. As described further below, a creator may create a verifiable social identity claim, by making a social media post containing their DID public key. A link (e.g., a uniform resource locator (URL)) to that social media post may then be mapped to the DID in a smart contract (e.g., a social DID contract) at the time of creation of the creator's DID. In this manner, a social DID is effectively vouched for by the third-party social media account through which the social identity claim was made.

As used herein, “proof of creation” of a digital artifact generally refers to proof that the digital artifact was created by a known entity. A non-limiting example of proof of creation of a digital artifact is an NFT caused to be minted by a proof of creation facilitator service by the creator of the digital artifact that includes metadata relating to the digital artifact and identifying the creator (e.g., with reference to a social DID of the creator) as the creator.

As used herein, “decentralized proof of creation” generally refers to proof of creation that is not bound to any particular NFT marketplace. For example, in various embodiments described herein, decentralized proof of creation of a given digital artifact may be created by a third-party service (e.g., a proof of creation facilitator service) that is separate and independent of any particular NFT marketplace and using a social DID.

As used herein, a “peer-to-peer file-sharing network” or “P2P file-sharing network” generally refers to a network through which participating computer systems may share files or digital artifacts. A non-limiting example of a P2P file-sharing network is the InterPlanetary File System (IPFS).

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability and mobility (e.g., cloud bursting for load balancing between clouds).

As used herein, a “weblink” or simply a “link” generally refers to an address of a resource, for example, on the web or within a P2P file-sharing network, depending on the context of usage. Non-limiting examples of a link include a uniform resource identifier (URI), a uniform resource locator (URL), and a content identifier (CID) (or a content address), for example, an IPFS hash.

The terms “module,” “component”, “engine”, “service,” and the like as used herein are intended to refer to a computer-related entity, either a software-executing general purpose processor, hardware, firmware, or a combination thereof. For example, a module or a component may be, but is not limited to being, a process running on a compute resource, an executable, a thread of execution, a program, and/or a computer.

Example Operational Environment

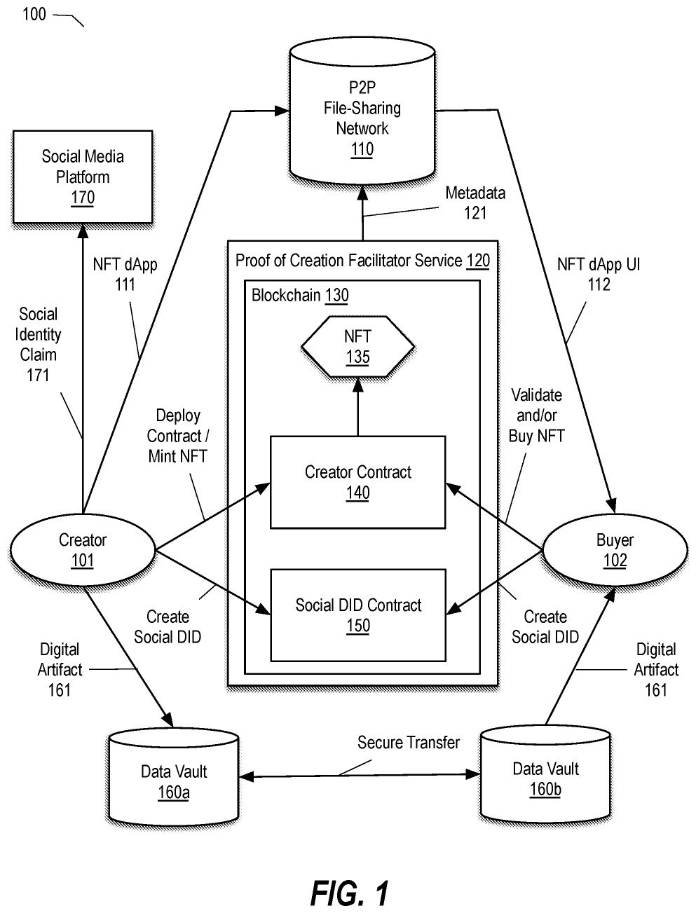

FIG. 1 is a block diagram illustrating an operational environment 100 for a proof of creation facilitator service according to some embodiments. According to one embodiment, to ensure there are no middlemen exerting control over a creator's creation, the proposed proof of creation facilitator service (e.g., proof of creation facilitator service 120) includes multiple blockchain smart contracts. Proof of creation facilitator service 120 may represent a service hosted by a public cloud (not shown) (e.g., Amazon Web Services, Microsoft Azure, Google Cloud Platform, or the like) and made accessible to end users via a SaaS delivery model.

Proof of creation facilitator service 120 may be represented by a blockchain 130, multiple smart contacts stored thereon and a web user interface (not shown) through which end users (e.g., creators and prospective purchasers or buyers) of the service interact with the smart contracts. In one embodiment, the web user interface is published to a P2P file-sharing network 110 and is accessible at a content identifier that represents a unique immutable address based on the content of the web user interface. Such an immutable address guarantees to the end user that the web user interface has not been modified or tampered with and is therefore the original website that a given creator (e.g., creator 101) used to mint a given NFT (e.g., NFT 135), which may represent proof of creation of a given digital artifact (e.g., digital artifact 161) and ownership of the given digital artifact.

As described further below, in one embodiment, proof of creation facilitator service 120 may leverage a social media platform 160 (e.g., Facebook, Twitter, Instagram, or the like) to serve as an underlying identity confirmation mechanism for social DIDs generated for end users (e.g., creators of digital artifacts and buyers/users of digital artifacts) via the proof of creation facilitator service 120.

Blockchain 130 may be used to store one social DID contract 150 deployed by or on behalf of the owner of proof of creation facilitator service 120. Blockchain 120 may also be used to store and one creator contract (e.g., creator contract 140) deployed by or on behalf of each creator (e.g., creator 101) that has been assigned a social DID by the social DID contract 150 for each digital artifact (e.g., digital artifact 151) created by the creator. For example, a given creator contract (e.g., creator contract 140) may be deployed from a wallet (e.g., an Ethereum wallet) of a given creator (e.g., creator 101) that is compatible with blockchain 130 and hence is controlled by a private key owned by the given creator. In one embodiment, blockchain 130 may represent an Ethereum blockchain; however, it is to be understood any blockchain that supports smart contacts may be used.

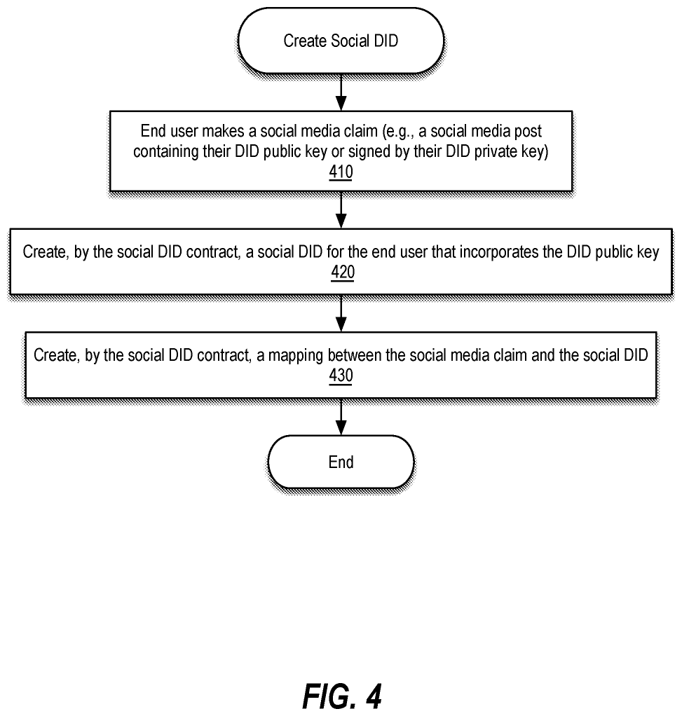

Social DID contract 150 may represent a smart contract that is deployed by proof of creation facilitator service 120. In the context of various embodiments described herein, all end users (e.g., creators of digital artifacts and buyers/users of digital artifacts) of proof of creation facilitator service 120 are expected to have an identity in the form of a social DID. This identity is used to establish who created or owns a particular digital artifact, for example, by initially associating the creator's social DID with a creator field and an owner field of the metadata of an NFT minted for the particular digital artifact and changing the owner field to reference the social DID of any subsequent buyer. According to one embodiment, an end user may create a social DID by invoking the social DID contract 150 with information from social media platform 160 that may be used to link the end user's social identity or social media handle on social media platform 160 with the social DID. A non-limiting example of creation of a social DID is described further below with reference to FIG. 4.

Creator contract 140 may represent a smart contact that runs on blockchain 120 that is responsible for minting, on behalf of creator 101, one or more NFTs (e.g., NFT 135) for a given digital artifact (e.g., digital artifact 161) created by creator 101 and controlling access to the given digital artifact via the one or more NFTs, for example, representing ownership of (or an ownership interest in) the given digital artifact. For example, creator contract 140 may enforce various policies specified by creator 101 as part of determining the permissibility of a particular transaction (e.g., purchase or lease) of digital artifact 161 or otherwise carrying out and completing the particular transaction (e.g., purchase or lease). Non-limiting examples of such policies include terms of sale, terms of lease, derivative use terms, and who is allowed to buy/use the given digital artifact (e.g., geographic limitations).

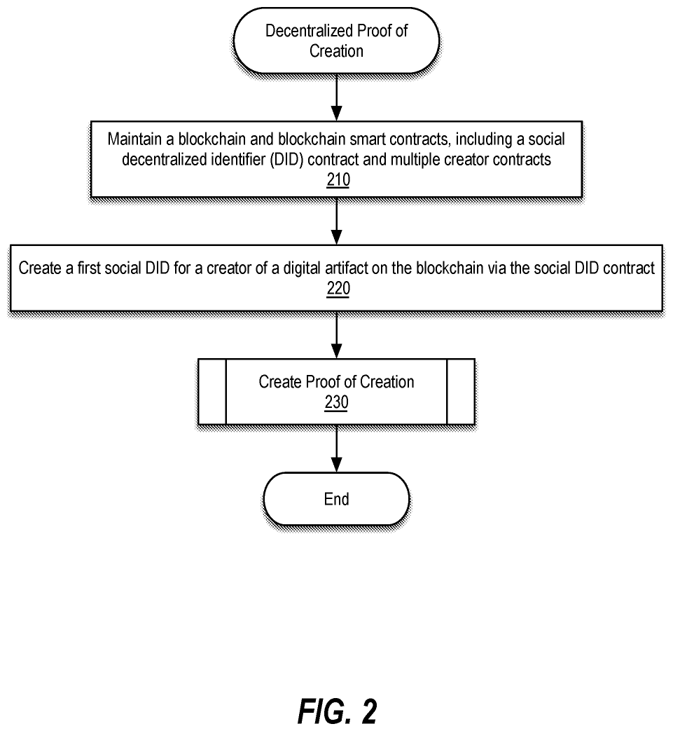

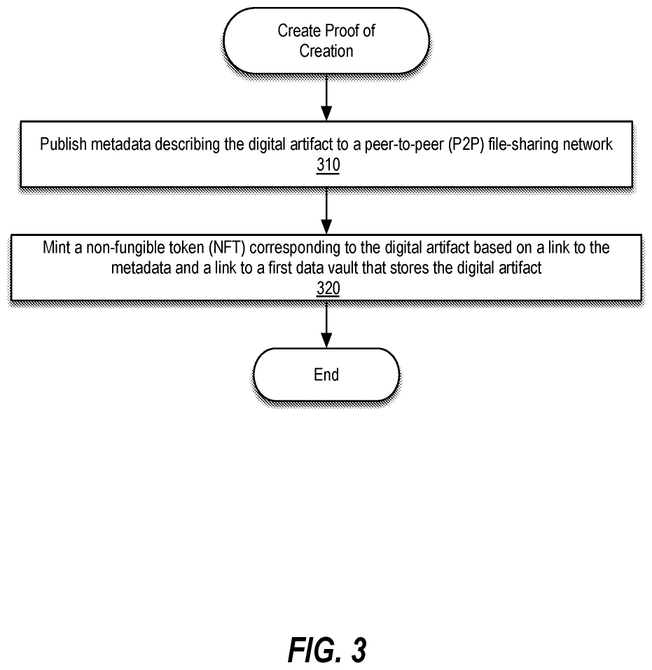

In the context of the present example, assuming creator 101 has created digital artifact 161 and would like to monetize (e.g., sell, lease, or trade) digital artifact 161, creator 101 may store digital artifact 161 in a private online data vault (e.g., data vault 160a). Additionally, as noted above, creator 101 is expected to have a social DID, which may be created and associated with a verifiable social identity claim (e.g., social identity claim 171) by social DID contract 160, for example, as described further below with reference to FIG. 4. Furthermore, creator 101 may deploy creator contract 140 on blockchain 130, which may be used to mint NFT 135, representing decentralized proof of creation of digital artifact 161, for example, by identifying creator 101 as both the creator and owner of digital artifact 161 by referencing the social DID of creator 101. Further details regarding facilitation of decentralized proof of creation, including, for example, creation of metadata 121 relating to digital artifact 161, publication of metadata 121 to P2P file-sharing network 110, and minting of NFT 135, are described below with reference to FIGS. 2 and 3.

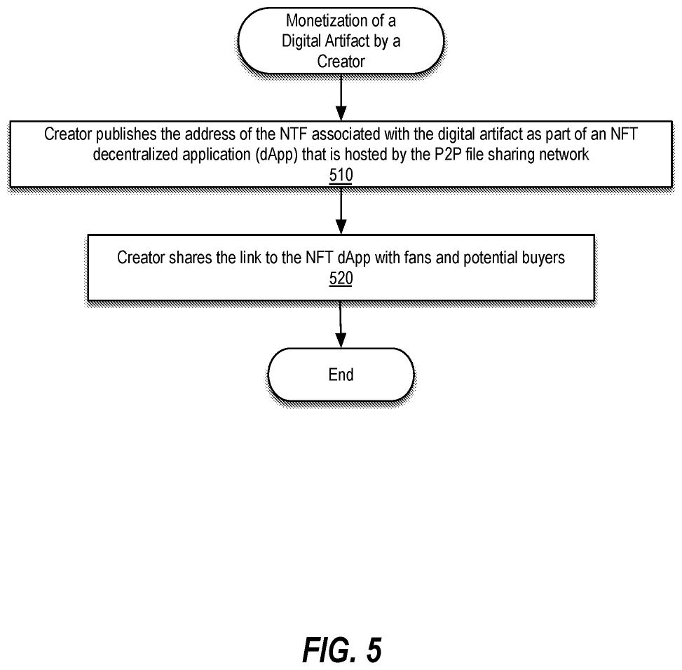

Upon successful creation of NFT 135, creator 101 may publish the address of NFT 135 on an NFT marketplace (not shown) through a corresponding NFT decentralized application (dApp) 111 hosted in P2P file-sharing network 110 and inform with his/her fans and potential buyers of the availability of NFT 135 for purchase, lease, or trade, for example, via social media (e.g., as part of a post on social media platform 170 and/or one or more other social media platforms), electronic mail (email), text message, or other electronic means. Further details regarding monetization of a digital artifact are described below with reference to FIG. 5.

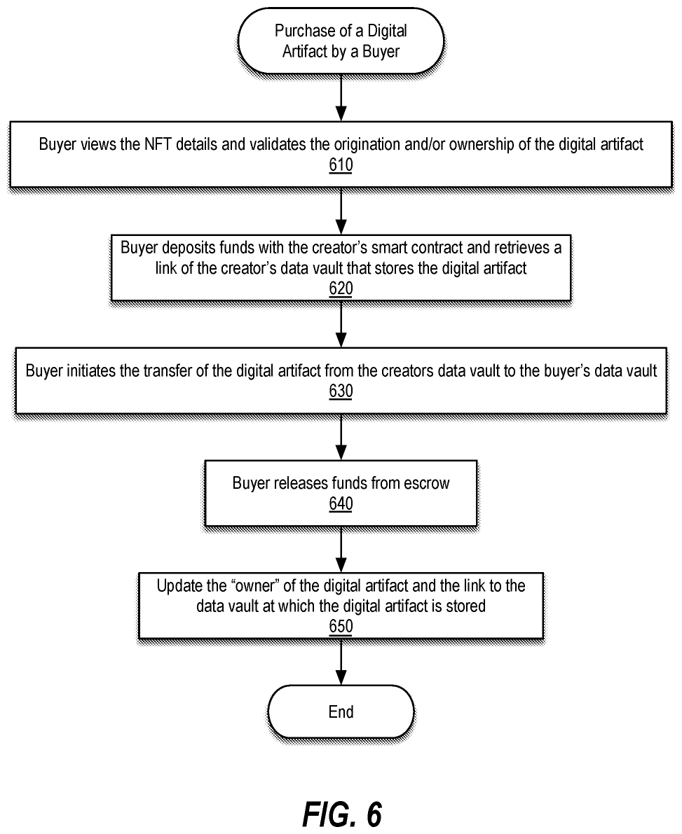

Assuming buyer 102 would like to purchase digital artifact 161 (via acquisition of NFT 135), buyer 102 is also expected to have a social DID, which may be created and associated with a verifiable social identity claim by social DID contract 160, for example, as described further below with reference to FIG. 4. Buyer 102 may then make use of creator contract 140 and a user interface (UI) of NFT dApp 112 to validate and/or buy NFT 135, including depositing of funds, secure transfer of digital artifact 161 from data vault 160a to a private online data vault (e.g., data vault 160b) of buyer 102, and updating the ownership of digital artifact 161, as described further below with reference to FIG. 6. Non-limiting examples of data vaults 160a-b include data storage and message relay mechanism entities or Identity Hubs, for example, as defined in the Decentralized Identity Foundation (DIF) Identity Hub specification currently available at https://identity.foundation/decentralized-web-node/spec/0.0.1-predraft/.

While in the context of the present example, for purposes of simplicity, a given creator contract (e.g., creator contract 140) is described as having a one-to-one relationship with a given digital artifact (e.g., digital artifact 151) created by a given creator (e.g., creator 101), it is to be appreciated, in alternative embodiments, there may be a one-to-many relationship between creator contracts and digital artifacts. Similarly, while only a single creator 101 and a single buyer 102 are shown, it is to be appreciated the end users of the proof of creation facilitator service 120 may include multiple creators and buyers.

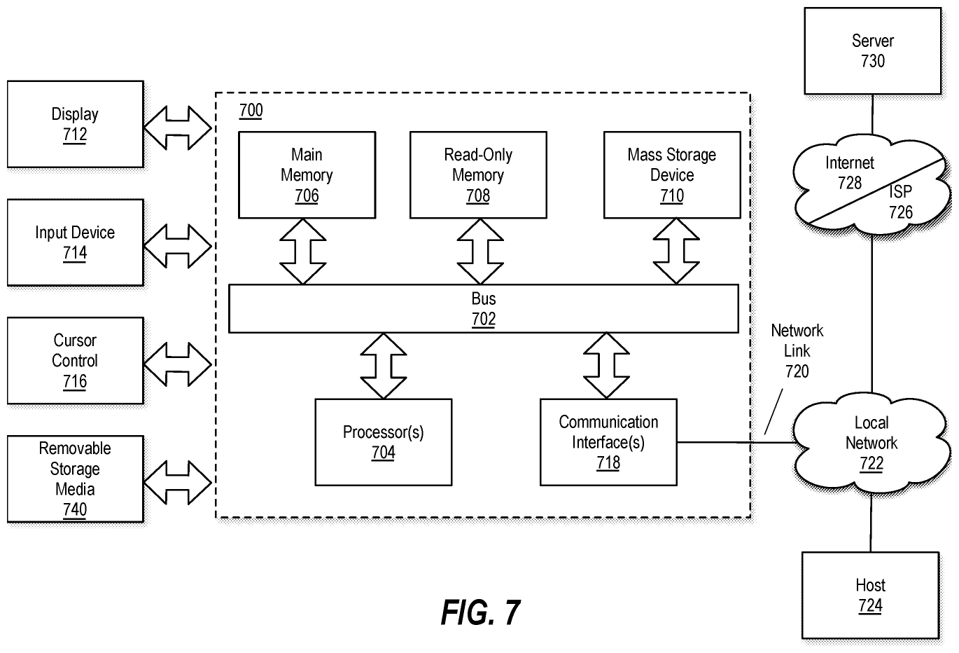

The various software components (e.g., proof of creation facilitator service 120, blockchain 130, creator contract 140, social DID contract 150, and data vaults 160a-b, and social media platform 170) described herein, and the processing described below may be implemented in the form of executable instructions stored on one or more machine readable media and executed by one or more processing resources (e.g., a microcontroller, a microprocessor, a CPU core, a CPU, a GPU, an xPU, an application-specific integrated circuit (ASIC), a field programmable gate array (FPGA), and the like) and/or in the form of other types of electronic circuitry. For example, the processing may be performed by one or more virtual or physical computer systems of various forms, such as, for example, the computer system described below with reference to FIG. 7.

Example Decentralized Proof of Creation

FIG. 2 is a flow diagram illustrating operations for facilitating decentralized proof of creation according to some embodiments. The process described with reference to FIG. 2 may be performed making use of a proof of creation facilitator service (e.g., proof of facilitator service 120).

At block 210, a blockchain (e.g., blockchain 130) and multiple smart contracts are maintained by the proof of creation facilitator service. The smart contracts may include a creator contract (e.g., creator contract 150) and a social DID contract (e.g., social DID contract 160). In one embodiment, the social DID contract is owned by and deployed on the blockchain by the operator of the proof of creation facilitator service, whereas the creator contract is owned by and deployed on the blockchain a creator (e.g., creator 101) of a given digital artifact (e.g., digital artifact 161), thereby precluding changes to monetization terms or conditions relating to the given digital artifact by a third party or entity (e.g., the operator of the proof of creation facilitator service, an NFT marketplace on which the given digital artifact is listed for sale, or others). As noted above, in one embodiment, the creator contract may be deployed from an Ethereum wallet of the creator resulting in the creator contract being controlled by a private key owned by the creator. In one embodiment, the creator may deploy a creator contract on the blockchain for each digital artifact he/she would like to monetize. Alternatively, there may be a one-to-many relationship between the creator contract and digital artifacts.

At block 220, a first social DID is created for the creator on the blockchain via the social DID contract. According to one embodiment, the creator may invoke the social DID contract by its unique identity (e.g., its script hash) and providing appropriate input parameters (e.g., a public key of an asymmetric keypair to be associated with the first social DID). In one embodiment the first social DID may represent a DID that is associated with a verifiable social identity claim (e.g., social identity claim 161). For example, as described further below with reference to FIG. 4, during creation of the first social DID, the social DID contract may persist an immutable record of the mapping between the first social DID and the verifiable social identity claim to the blockchain.

At block 230, proof of creation for the digital artifact is created. According to one embodiment, the creator invokes the creator contract associated with the digital artifact to create a decentralized proof of creation for the digital artifact, for example, in the form of a newly minted NFT (e.g., NFT 135) stored on the blockchain and representing ownership of the digital artifact. The NFT may include metadata relating to the digital artifact including, among other information for fields, information identifying a known entity (in this case, creator 101) as the creator of the digital artifact. For example, the metadata may include a creator field that references the first social DID. Use of a social DID, which is not bound to any NFT marketplace, as part of the decentralized proof of creation also makes the decentralized proof of creation independent of any NFT marketplace and makes the decentralized proof of creation accessible and capable of validation by any end user of the proof of creation facilitator service. A non-limiting example of creation of proof of creation by the creator contract is described further below with reference to FIG. 3.

Example Creation of Proof of Creation

FIG. 3 is a flow diagram illustrating operations for creating proof of creation according to some embodiments. The process described with reference to FIG. 3 represents a non-limiting example of processing performed within block 230 of FIG. 2 and may be performed making use of a proof of creation facilitator service (e.g., proof of facilitator service 120). In the context of the present example, it is assumed a creator (e.g., creator 101) of a digital artifact (e.g., digital artifact 161) has stored an original version of the digital artifact within a first data vault (e.g., data vault 160a) and has created metadata (e.g., metadata 121) describing the digital artifact. The metadata describing the digital artifact may include, among other information and/or fields, a name of the digital artifact, a description of the digital artifact, a link to a scaled down or low resolution copy of the digital artifact, a zero-knowledge proof that scaled down or low resolution image is of the original digital artifact that the creator possess, an identity (e.g., a social DID) of the creator of the digital artifact, and/or an identity of the owner of the digital artifact and may be stored in a metadata file.

At block 310, the metadata describing the digital artifact is published to a P2P file-sharing network (e.g., P2P file-sharing network 110) for permanent storage. In one embodiment, in addition to publishing the metadata to the P2P file-sharing network, the creator may also publish the scaled down or low resolution image of the digital artifact to the P2P file-sharing network. A non-limiting example of the P2P file-sharing network is the IPFS.

At block 320, a creator contract (e.g., creator contract 150) deployed by the creator on a blockchain (e.g., blockchain 130) of the proof of creation facilitator service may be invoked by the creator to mint an NFT (e.g., NFT 135) to represent creation and ownership of the digital artifact. In one embodiment, input parameters to the minting function of the creator contract may include a link to the metadata stored on the P2P file-sharing network and a link to the first data vault that stores the digital artifact (e.g., a link to the digital artifact contained within the first data vault, which might contain multiple digital artifacts—either created or bought). After successful creation of the NFT (that includes the two links), the NFT is stored on the blockchain and the creator contract may return an address of the NFT on the blockchain to the creator.

Example Creation of a Social DID

FIG. 4 is a flow diagram illustrating operations for creating a social decentralized identifier (DID) according to some embodiments. The process described with reference to FIG. 4 may be performed making use of a proof of creation facilitator service (e.g., proof of facilitator service 120). End users (e.g., creator 101 and buyer 102) of the proof of facilitator service are expected to have a social DID before they can participate in minting NFTs and/or a transaction relating to an NFT.

At block 410, an end user (e.g., creator 101 or buyer 102) of a proof of creation facilitator service (e.g., proof of creation facilitator service 120) may make a social media claim or a social identity claim (e.g., social identity claim 171), for example, in the form of a social media post containing the public key of an asymmetric keypair that will be associated with their social DID or a social media post that is signed by the private key of the asymmetric keypair that will be associated with their social DID.

At block 420, a social DID contract (e.g., social DID contract 160) creates a social DID for the end user that incorporates the public key. For example, the creator may invoke a minting function of the social DID contract with input parameters, including the public key and a link to the social identity claim and based thereon the social DID contract may generate a new social DID for the creator, store the new social DID to the blockchain, and return an address of the new social DID to the creator. A non-limiting example of a format of a social DID is DID::<Proof of Creation Facilitator Service Operator>:SocialDIDContractAddress::DIDNumber.

At block 430, during the minting function, the social DID contract may also create a mapping between the social identity claim and the social DID by persisting a record containing the link to the social identity claim to the blockchain, thereby allowing other end users to verify the end user possessing the private key associated with the social DID as one in the same as the end user of the social media platform (e.g., social media platform 170) that made the social identity claim.

Example Monetization of an NFT

FIG. 5 is a flow diagram illustrating operations for monetization of an NFT (e.g., NFT 135) minted by a proof of creation facilitator service (e.g., proof of creation facilitator service 120) according to some embodiments. The process described with reference to FIG. 5 may be performed at least in part by a creator (e.g., creator 101) making use of operational environment 100. In the context of the present example, it is assumed the creator has created a digital artifact (e.g., digital artifact 161), stored an original of the digital artifact in a private data vault (e.g., data vault 160a), created a social DID (e.g., in accordance with FIG. 4), created decentralized proof of creation in the form of NFT 135 for the digital artifact (e.g., in accordance with FIG. 3), and would now like to monetize the NFT.

At block 510, the creator publishes the address of the NFT as part of an NFT decentralized application (dApp) that is hosted by a P2P file-sharing network (e.g., P2P file-sharing network 110) and through which a corresponding NFT marketplace may be accessed.

At block 520, the creator may then advertise the availability of the NFT for purchase, lease, or trade by sharing the link to the NFT dApp with fans and potential buyers, for example, via social media (e.g., as part of a post on a social media platform (e.g., social media platform170) and/or one or more other social media platforms), email, text message, or other electronic means.

Example Purchase of an NFT

FIG. 6 is a flow diagram illustrating operations for purchasing an NFT (e.g., NFT 135) minted by a proof of creation facilitator service (e.g., proof of creation facilitator service 120) according to some embodiments. The process described with reference to FIG. 6 may be performed at least in part by a buyer (e.g., buyer 102) making use of operational environment 100. Assuming the buyer would like to purchase a digital artifact (e.g., digital artifact 161 via acquisition of NFT 135), buyer 102 is also expected to have a social DID, which may be created and associated with a verifiable social identity claim by social DID contract 160, for example, as described above with reference to FIG. 4. Buyer 102 may then make use of creator contract 150 and a user interface (UI) (e.g., NFT dApp UI 112) of the NFT dApp (e.g., NFT dApp 111) of the corresponding NFT marketplace to which a creator (e.g., creator 101) of the digital artifact has listed the NFT to validate and/or buy the NFT, for example, via a buy button presented via the NFT dApp.

At block 610, the buyer may view the NFT details and validate the origination and/or ownership of the digital artifact. For example, the buyer may view the owner field to confirm the current owner and the creator field to confirm the origination of the digital artifact. The buyer may also validate the digital artifact originated from the creator based on the public key of the asymmetric keypair, for example, by verifying a social identity claim (e.g., social identity claim 171) made by the creator on a social media platform (e.g., social media platform 170). Alternatively or additionally, the buyer may issue an identity challenge to the purported creator to which the creator may respond with an identity claim signed by the private key of the asymmetric keypair associated with the social DID of the creator. The buyer may then verify the identity claim with the public key of the asymmetric keypair associated with the social DID of the creator. The buyer may also fetch other NFT details, for example, discounts offered by the creator for frequent buyers, the price, etc. and other configured policies from the creator's private data vault (e.g., data vault 160a) by signing a request with the private key of an asymmetric keypair associated with the buyer's social DID.

At block 620, assuming the buyer wants to proceed with the purchase of the NFT, the buyer deposits funds with the creator's smart contract (e.g., creator contract 150) and retrieves a link of the creator's data vault that stores the digital artifact.

At block 630, the buyer initiates the transfer of the digital artifact from the creator's data vault to the buyer's data vault (e.g., data vault 160b). For example, the buyer may invoke a transfer function of the creator's smart contract, providing a link to the buyer's data vault as an input parameter. Responsive to the buyer's request, the buyer's data vault may establish a trusted connection with the creator's data vault, the creator's data vault may check with creator's smart contract to verify there is a deposit entry from the buyer's social DID for the NFT, and once verified, the creator's data vault will transfer the digital asset to the buyer's data vault (and the buyer in case of IPFS should pin the NFT metadata).

At block 640, after the digital artifact has been successfully transferred to the buyer's data vault, the buyer releases the funds from escrow, for example, by signing the transaction with their crypto wallet (e.g., Metamask or the like) and the creator's smart contract then updates the ownership of the NFT to reflect the buyer as the new owner by updating the owner field of the NFT metadata to reference the social DID of the buyer as well as updating the link to the original version of the digital artifact to a link to the buyer's data vault that now stores the original digital artifact.

According to one embodiment, the creator's smart contract may also emit events that the creator could listen to and pull in the funds to his/her wallet. Also, as will be appreciated by those skilled in the art, any transaction relating to the digital artifact becomes part of the NFT's transfer history and is accessible to any future buyers who would like to view the transfer history.

While in the context of the examples described with reference to the flow diagrams of FIGS. 2-6, a number of enumerated blocks are included, it is to be understood that examples may include additional blocks before, after, and/or in between the enumerated blocks. Similarly, in some examples, one or more of the enumerated blocks may be omitted and/or performed in a different order.

Example Computer System

FIG. 7 is an example of a computer system 700 with which some embodiments may be utilized. Computer system 700 may represent some, all, or a subset of components of one or more computer systems on which a proof of creation facilitator service (e.g., proof of creation facilitator service 120) is run and/or a client computer system utilized by an end user (e.g., creator 101 or buyer 102) of the proof of creation facilitator service. Notably, components of computer system 700 described herein are meant only to exemplify various possibilities. In no way should example computer system 700 limit the scope of the present disclosure. In the context of the present example, computer system 700 includes a bus 702 or other communication mechanism for communicating information, and a processing resource (e.g., one or more hardware processors 704) coupled with bus 702 for processing information. The processing resource may be, for example, one or more general-purpose microprocessors or a system on a chip (SoC) integrated circuit.

Computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, e.g., a magnetic disk, optical disk or flash disk (made of flash memory chips), is provided and coupled to bus 702 for storing information and instructions.

Computer system 700 may be coupled via bus 702 to a display 712, e.g., a cathode ray tube (CRT), Liquid Crystal Display (LCD), Organic Light-Emitting Diode Display (OLED), Digital Light Processing Display (DLP) or the like, for displaying information to a computer user. An input device 714, including alphanumeric and other keys, is coupled to bus 702 for communicating information and command selections to processor 704. Another type of user input device is cursor control 716, such as a mouse, a trackball, a trackpad, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Removable storage media 740 can be any kind of external storage media, including, but not limited to, hard-drives, floppy drives, IOMEGA® Zip Drives, Compact Disc-Read Only Memory (CD-ROM), Compact Disc—Re-Writable (CD-RW), Digital Video Disk-Read Only Memory (DVD-ROM), USB flash drives and the like.

Computer system 700 may implement the techniques described herein using customized hard-wired logic, one or more ASICs or FPGAs, firmware or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 710. Volatile media includes dynamic memory, such as main memory 706. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes interface circuitry 718 coupled to bus 702. The interface circuitry 718 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. As such, interface 718 may couple the processing resource in communication with one or more discrete accelerators (e.g., one or more XPUs).

Interface 718 may also provide a two-way data communication coupling to a network link 720 that is connected to a local network 722. For example, interface 718 may be an integrated services digital network (ISDN) card, cable modem, satellite modem, or a modem to provide a data communication connection to a corresponding type of telephone line. As another example, interface 718 may be a local area network (LAN) card to provide a data communication connection to a compatible LAN. Wireless links may also be implemented. In any such implementation, interface 718 may send and receive electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, or stored in storage device 710, or other non-volatile storage for later execution.

While many of the methods may be described herein in a basic form, it is to be noted that processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments require more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for operating a proof of creation facilitator service according to embodiments and examples described herein.

Some embodiments pertain to Example 1 that includes a method comprising: maintaining a blockchain and smart contracts, including a social decentralized identifier (DID) contract and a plurality of creator contracts; creating a first social DID for a creator of a digital artifact on the blockchain via the social DID contract; and based at least in part on the first social DID, creating decentralized proof of creation for the digital artifact on the blockchain via a creator contract of the plurality of creator contracts deployed by or on behalf of the creator.

Example 2 includes the subject matter of Example 1, wherein said creating decentralized proof of creation for the digital artifact comprises publishing metadata describing the digital artifact to a peer-to-peer (P2P) file sharing network, wherein the metadata includes at least the first social DID.

Example 3 includes the subject matter of Example 2, wherein said creating decentralized proof of creation for the digital artifact further comprises without requiring the digital artifact to be uploaded to a non-fungible token (NFT) marketplace associated with the P2P file sharing network, minting, by the creator contract, an NFT corresponding to the digital artifact based on a link to the metadata and a link to a first data vault that stores the digital artifact.

Example 4 includes the subject matter of any of Examples 1-3, wherein the first social DID is identified by a private-public key pair including a private key maintained by the creator and a public key.

Example 5 includes the subject matter of Example 4, wherein said creating a first social DID comprises forming an association by the social DID contract between the first social DID and a link to a social identity claim made by the creator in a form of a social media post by the creator that contains the public key or that is signed by the private key.

Example 6 includes the subject matter of any of Examples 1-5, further comprising creating a second social DID for a prospective buyer of the digital artifact on the blockchain via the social DID contract.

Example 7 includes the subject matter of Example 6, f further comprising facilitating monetization of the digital art by publishing an address of the NFT to the NFT marketplace for viewing by the prospective buyer.

Example 8 includes the subject matter of Example 7, further comprising: receiving, by the creator contract, funds deposited by the prospective buyer; and providing, by the creator contract, the link to the first data vault to the prospective buyer.

Example 9 includes the subject matter of Example 8, further comprising prior to transferring the digital artifact from the first data vault to a second data vault of the prospective buyer, verifying, by the creator contract, existence of a deposit entry on the blockchain associated with the second social DID for the NFT.

Example 10 includes the subject matter of Example 9, wherein current ownership of the digital artifact is identified within the metadata with reference to an owner social DID, which is initially set to the first social DID.

Example 11 includes the subject matter of Example 10, further comprising after release of the funds from escrow by the prospective buyer, updating the current owner social DID to the second social DID.

Example 12 includes the subject matter of Example 6, wherein interactions with the NFT marketplace, the social DID contract, and the creator contract by the creator and the prospective buyer are via a web user interface that is published to the P2P file sharing network.

Example 13 includes the subject matter of any of Examples 1-12, further comprising enforcing, by the creator contract, restrictions on types of transactions in which the digital artifact may be involved based on conditions defined by the creator and associated with the NFT.

Example 14 includes the subject matter of any of Examples 1-13, wherein origination of the digital artifact is identified within the metadata with reference to an originator DID that set to the first DID and maintained throughout a transfer history of the digital artwork.

Example 15 includes the subject matter of any of Examples 1-14, wherein the P2P sharing network is based on an InterPlanetary File System (IPFS) protocol.

Some embodiments pertain to Example 16 that includes a non-transitory machine-readable medium storing instructions, which when executed by one or more processing resources of one or more computer systems cause the one or more computer systems to: maintain a blockchain and smart contracts, including a social decentralized identifier (DID) contract and a plurality of creator contracts; create a first social DID for a creator of a digital artifact on the blockchain via the social DID contract; and based at least in part on the first social DID, create decentralized proof of creation for the digital artifact on the blockchain via a creator contract of the plurality of creator contracts deployed by or on behalf of the creator.

Example 17 includes the subject matter of Example 16, wherein creation of the decentralized proof of creation for the digital artifact comprises publishing metadata describing the digital artifact to a peer-to-peer (P2P) file sharing network, wherein the metadata includes at least the first social DID.

Example 18 includes the subject matter of Example 16 or 17, wherein the first social DID is identified by a private-public key pair including a private key maintained by the creator and a public key.

Example 19 includes the subject matter of Example 18, wherein creation of the first social DID comprises forming an association by the social DID contract between the first social DID and a link to a social identity claim made by the creator in a form of a social media post by the creator that contains the public key or that is signed by the private key.

Example 20 includes the subject matter of any of Examples 17-19, wherein the instructions further cause the one or more computer systems to enforce, by the creator contract, restrictions on types of transactions in which the digital artifact may be involved based on conditions defined by the creator and associated with the NFT.

Some embodiments pertain to Example 21 that includes an apparatus or a system that implements or performs a method of any of Examples 1-16.

Example 22 includes at least one machine-readable medium comprising a plurality of instructions, when executed on a computing device, implement or perform a method or realize an apparatus as described in any preceding Example.

Example 23 includes an apparatus comprising means for performing a method as claimed in any of Examples 1-16.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A method comprising:
maintaining a blockchain and smart contracts, including a social decentralized identifier (DID) contract and a plurality of creator contracts;
creating a first social DID for a creator of a digital artifact on the blockchain via the social DID contract; and
based at least in part on the first social DID, creating decentralized proof of creation for the digital artifact on the blockchain via a creator contract of the plurality of creator contracts deployed by or on behalf of the creator.

2. The method of claim 1, wherein said creating decentralized proof of creation for the digital artifact comprises publishing metadata describing the digital artifact to a peer-to-peer (P2P) file sharing network, wherein the metadata includes at least the first social DID.

3. The method of claim 2, wherein said creating decentralized proof of creation for the digital artifact further comprises without requiring the digital artifact to be uploaded to a non-fungible token (NFT) marketplace associated with the P2P file sharing network, minting, by the creator contract, an NFT corresponding to the digital artifact based on a link to the metadata and a link to a first data vault that stores the digital artifact.

4. The method of claim 1, wherein the first social DID is identified by a private-public key pair including a private key maintained by the creator and a public key.

5. The method of claim 4, wherein said creating a first social DID comprises forming an association by the social DID contract between the first social DID and a link to a social identity claim made by the creator in a form of a social media post by the creator that contains the public key or that is signed by the private key.

6. The method of claim 1, further comprising creating a second social DID for a prospective buyer of the digital artifact on the blockchain via the social DID contract.

7. The method of claim 6, further comprising facilitating monetization of the digital art by publishing an address of the NFT to the NFT marketplace for viewing by the prospective buyer.

8. The method of claim 7, further comprising:
receiving, by the creator contract, funds deposited by the prospective buyer; and
providing, by the creator contract, the link to the first data vault to the prospective buyer.

9. The method of claim 8, further comprising prior to transferring the digital artifact from the first data vault to a second data vault of the prospective buyer, verifying, by the creator contract, existence of a deposit entry on the blockchain associated with the second social DID for the NFT.

10. The method of claim 9, wherein current ownership of the digital artifact is identified within the metadata with reference to an owner social DID, which is initially set to the first social DID.

11. The method of claim 10, further comprising after release of the funds from escrow by the prospective buyer, updating the current owner social DID to the second social DID.

12. The method of claim 6, wherein interactions with the NFT marketplace, the social DID contract, and the creator contract by the creator and the prospective buyer are via a web user interface that is published to the P2P file sharing network.

13. The method of claim 1, further comprising enforcing, by the creator contract, restrictions on types of transactions in which the digital artifact may be involved based on conditions defined by the creator and associated with the NFT.

14. The method of claim 1, wherein origination of the digital artifact is identified within the metadata with reference to an originator DID that set to the first DID and maintained throughout a transfer history of the digital artwork.

15. The method of claim 1, wherein the P2P sharing network is based on an InterPlanetary File System (IPFS) protocol.

16. A non-transitory machine-readable medium storing instructions, which when executed by one or more processing resources of one or more computer systems cause the one or more computer systems to:
maintain a blockchain and smart contracts, including a social decentralized identifier (DID) contract and a plurality of creator contracts;
create a first social DID for a creator of a digital artifact on the blockchain via the social DID contract; and
based at least in part on the first social DID, create decentralized proof of creation for the digital artifact on the blockchain via a creator contract of the plurality of creator contracts deployed by or on behalf of the creator.

17. The non-transitory machine-readable medium of claim 16, wherein creation of the decentralized proof of creation for the digital artifact comprises publishing metadata describing the digital artifact to a peer-to-peer (P2P) file sharing network, wherein the metadata includes at least the first social DID.

18. The non-transitory machine-readable medium of claim 16, wherein the first social DID is identified by a private-public key pair including a private key maintained by the creator and a public key.

19. The non-transitory machine-readable medium of claim 18, wherein creation of the first social DID comprises forming an association by the social DID contract between the first social DID and a link to a social identity claim made by the creator in a form of a social media post by the creator that contains the public key or that is signed by the private key.

20. The non-transitory machine-readable medium of claim 17, wherein the instructions further cause the one or more computer systems to enforce, by the creator contract, restrictions on types of transactions in which the digital artifact may be involved based on conditions defined by the creator and associated with the NFT.
